(19) United States
(12) Patent Application Publication
(10) Pub. No.: US 2021/0079231 A1
(43) Pub. Date: Mar. 18, 2021

(54) CORROSION PROTECTION FOR METALLIC SUBSTRATES COMPRISING ONE OR MORE 2D MATERIAL PLATELETS

(71) Applicant: APPLIED GRAPHENE MATERIALS UK LIMITED, Redcar (GB)

(72) Inventors: William Weaver, Redcar (GB); Lynn Chikosha, Redcar (GB); Gaven Johnson, Redcar (GB); Matthew David Sharp, Redcar (GB)

(21) Appl. No.: 17/046,290

(22) PCT Filed: Apr. 9, 2019
(86) PCT No.: PCT/GB2019/051030

§ 371 Date: Oct. 8, 2020

(30) Foreign Application Priority Data
Apr. 9, 2018 (GB) 1805856.0

(51) Int. Cl. C09D 5/08; C09D 163/00; C09D 7/40

(52) U.S. Cl. CPC C09D 5/084; C09D 7/70; C09D 163/00

(57) ABSTRACT

A composition comprising a carrier medium, a first corrosion inhibitor, and a second corrosion inhibitor having a barrier mechanism. The first corrosion inhibitor comprises at least one of an ion exchanged pigment, a silica, a calcium exchanged silica, an oxyaminophosphate salt of magnesium, and/or a mixture of an organic amine, a phosphoric acid and/or an inorganic phosphate and a metal oxide and/or a metal hydroxide, and the second corrosion inhibitor comprises one or more 2D material platelets in which the 2D material platelets comprise: nanoplates of one or more 2D materials and or nanoplates of one or more layered 2D materials and or graphite flakes in which the graphite flakes have one nanoscale dimension and 35 or less layers of atoms.

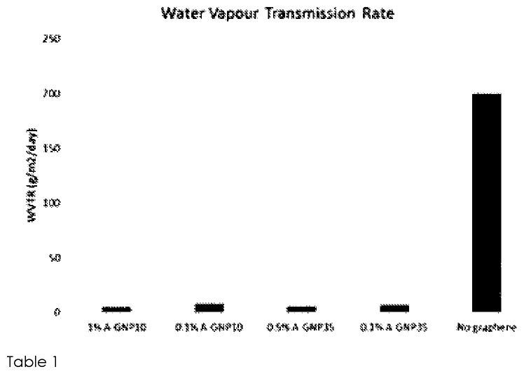

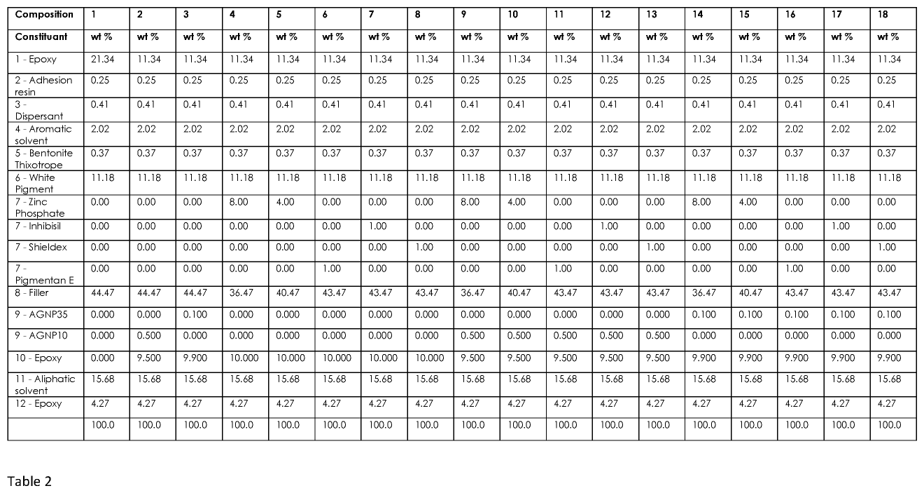

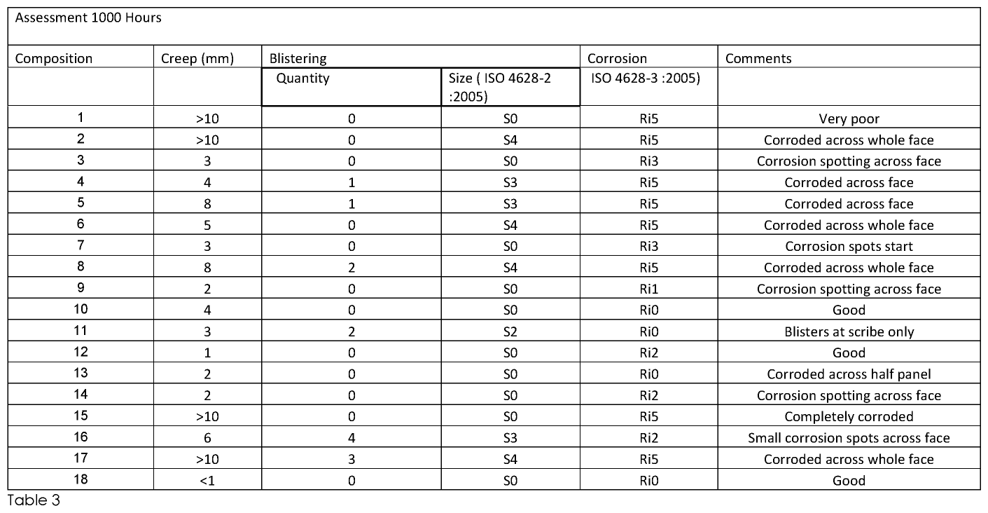

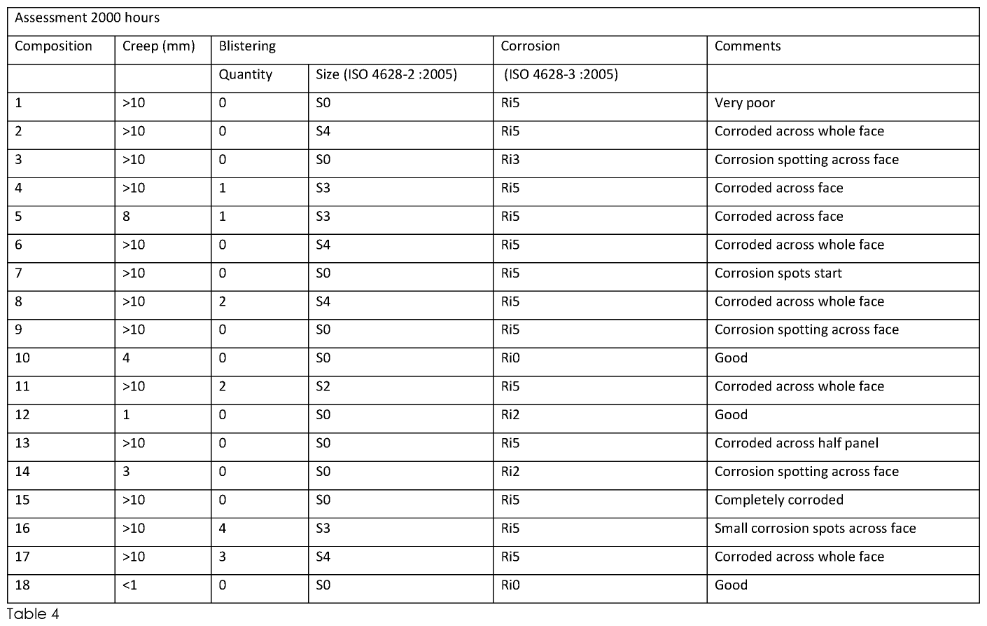

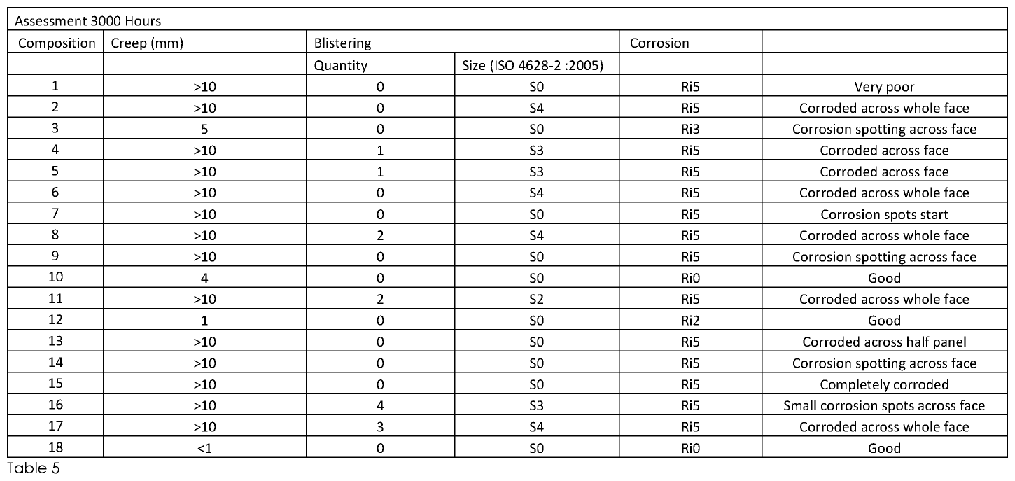

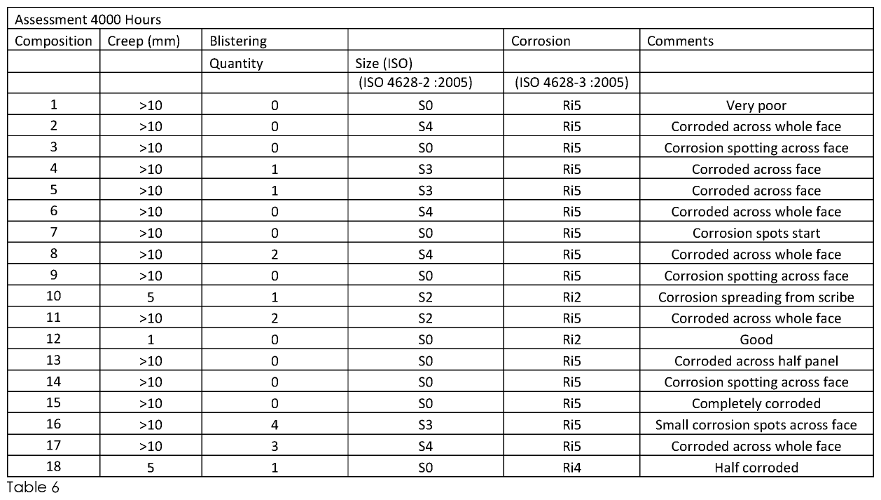

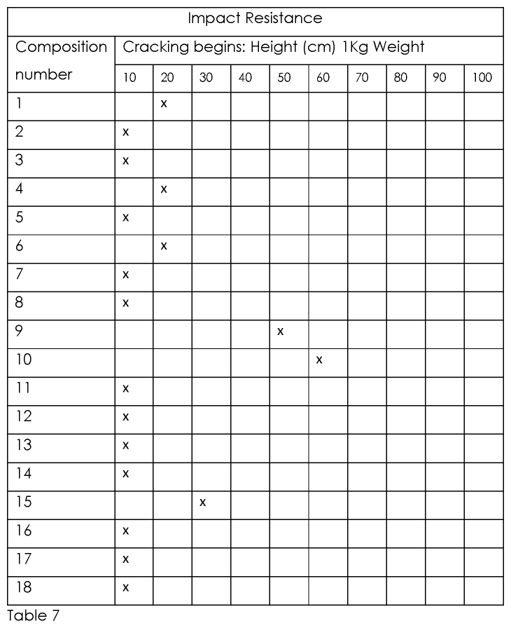

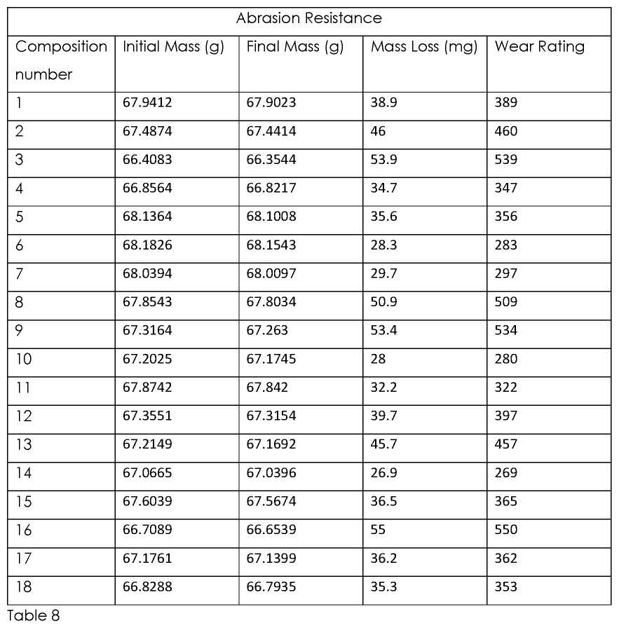

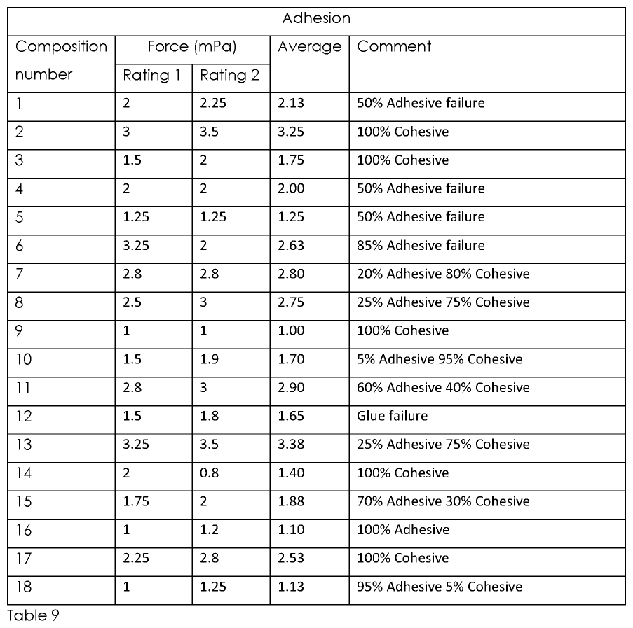

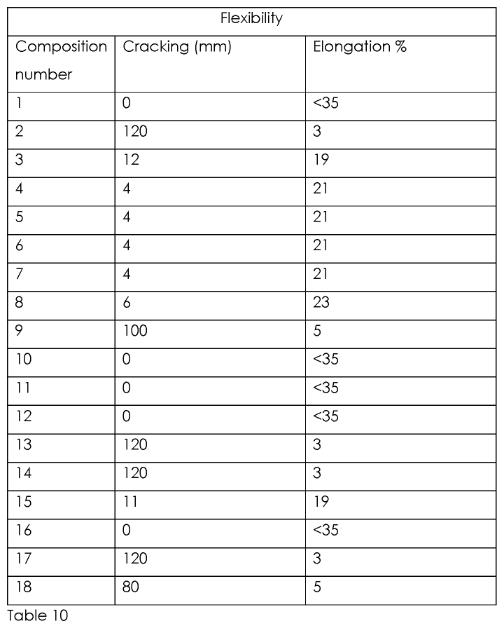

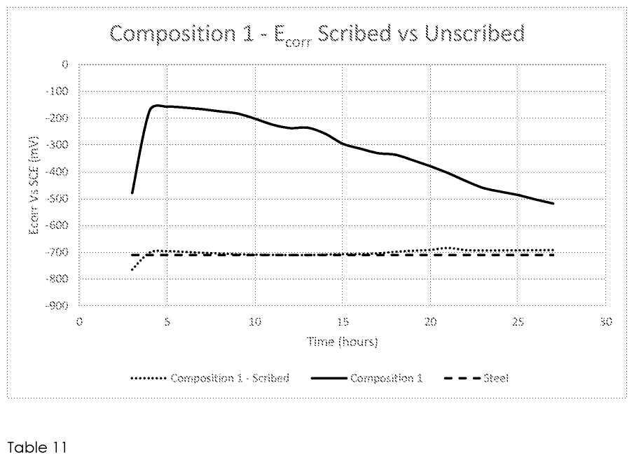

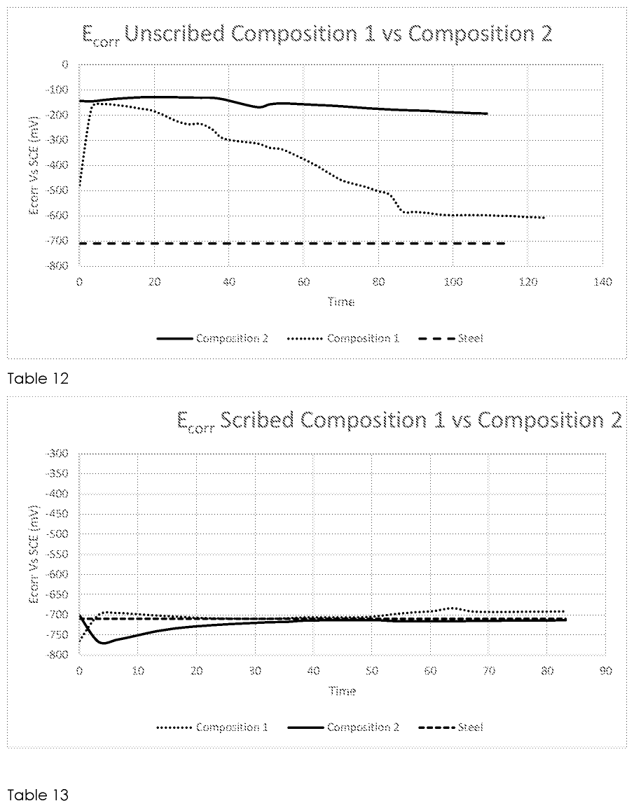

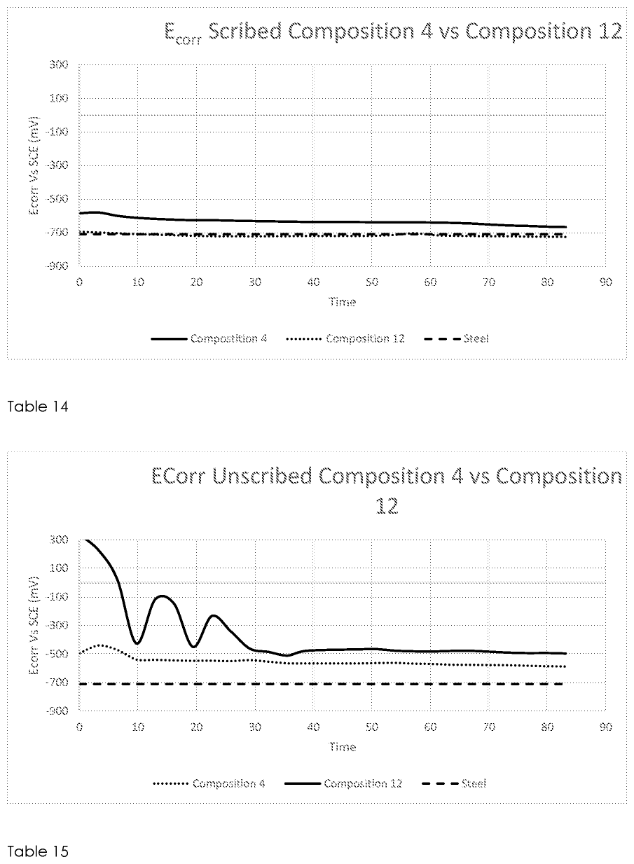

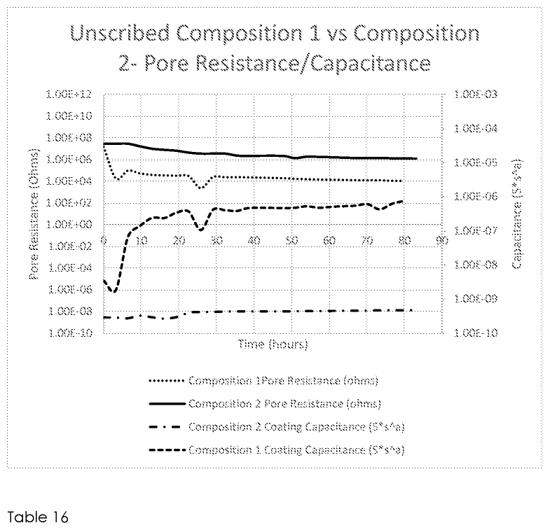

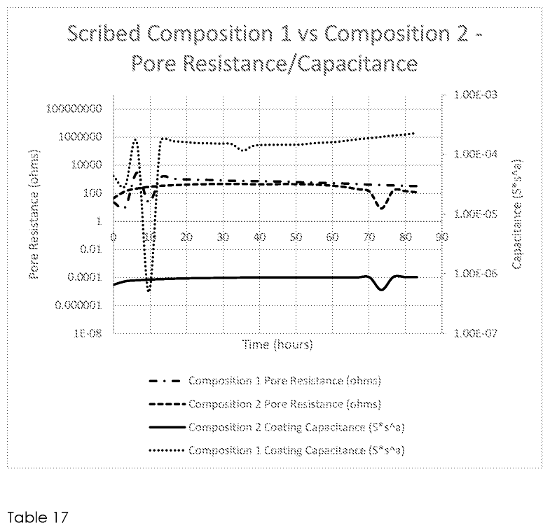

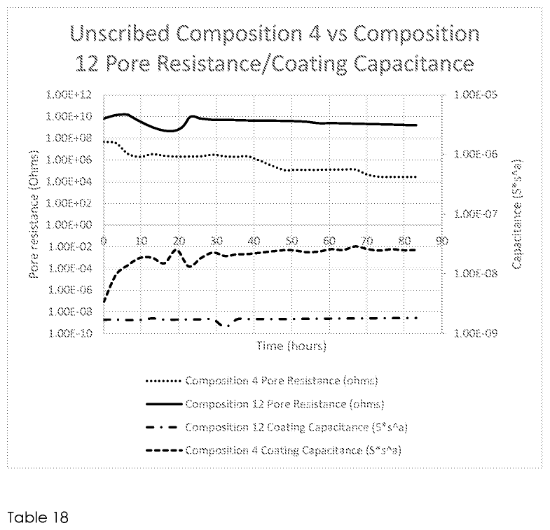

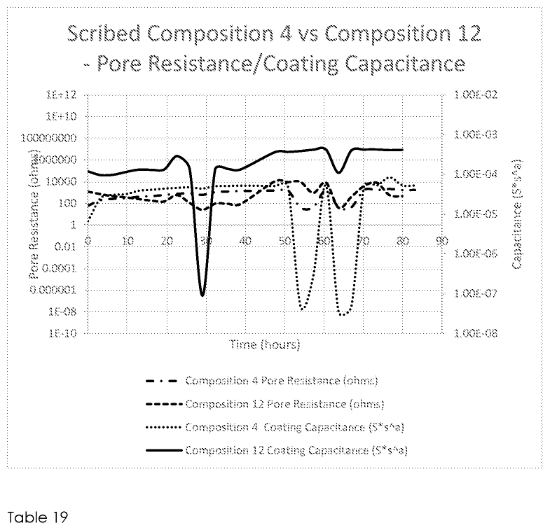

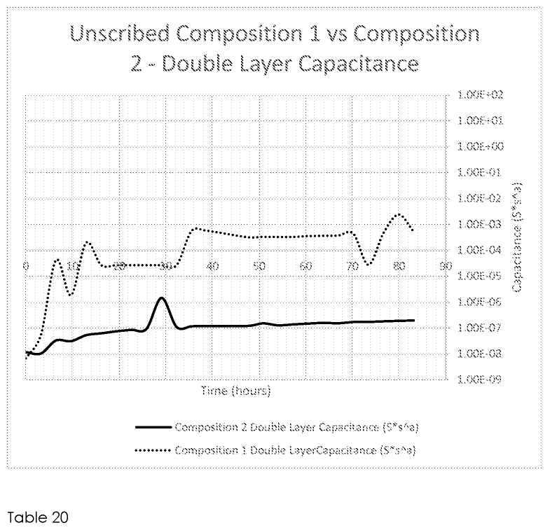

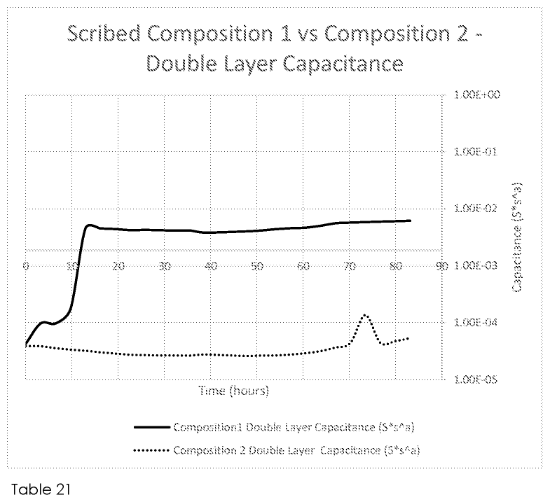

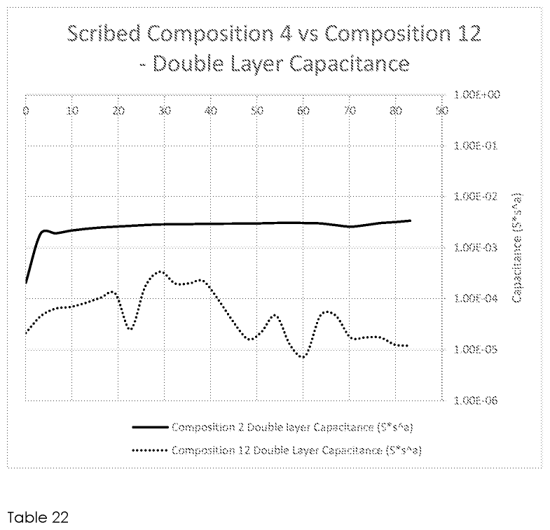

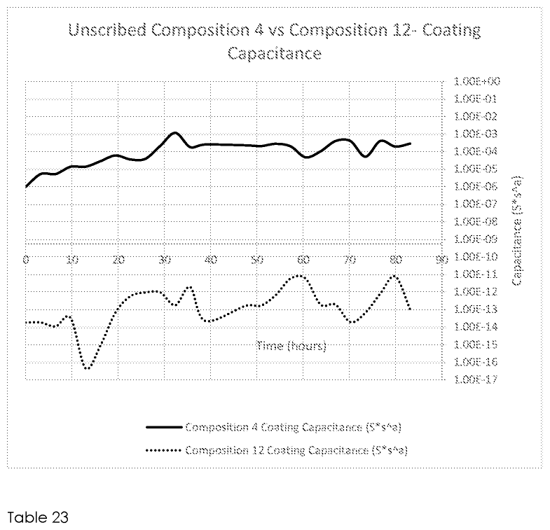

### CROSS REFERENCE TO RELATED APPLICATIONS

This application is a US national stage entry of International Patent Application No. PCT/GB2019/051030, filed Apr. 9, 2019, which claims priority to GB1805856.0, filed Apr. 9, 2018, the entire contents of each of which are incorporated by reference herein.

### BACKGROUND OF THE DISCLOSURE

This invention relates to corrosion protection for metallic substrates. In particular, this application relates to corrosion protection for metallic substrates such as but not limited to steel, aluminium, aluminium alloys and magnesium alloys.

Corrosion of metal has been estimated to cost about 3% of global Gross Domestic Product (GDP) and constitutes a significant aspect of the global economy. There is substantial interest in the development of new and improved anticorrosive technology, and in particular anticorrosive coatings. Anticorrosive coatings are generally classified in accordance with the mechanisms by which they operate. Two common mechanisms are barrier protection, and inhibition or passivation of the substrate.

Coatings employing the barrier mechanism, so called barrier coatings, may be used as primer, intermediate or top coat coatings and are often used on structures immersed in water or in the ground. Barrier coatings are typified by the use of inert pigmentation such as micaceous iron oxide, glass flake and lamellar aluminium. These systems are typically used as high pigment volume concentration (PVC) systems and give dense coatings with significantly reduced permeability to water and other aggressive species. The level of protection is highly dependent on the thickness of the coating, number of coats and have been reported to provide the highest performance when the thickness of the coating is built up from several thin coats.

The most common pigment used in barrier coatings is micaceous iron oxide. The optimum performance is obtained with a reduced PVC in the range of 0.5% to 1.5%.

When lamellar aluminium is used as the pigment, it is typically the leafing grade. Aluminium based paints or coatings need to be applied as a first coat to impact on cathodic disbonding. Aluminium may also corrode at high and low pH and may therefore corrode by reaction with hydroxyl groups formed at the cathode of any electro chemical cell formed at the metallic substrate/coating interface. Use of glass flake is typically restricted to very thick coatings due to the large size of the flake (100 μm to 1000 μm).

Coatings employing the inhibitive or passivation mechanism, so called Inhibitive coatings, are primarily applied as primers because they function by the reaction of constituents/pigments of the coating with the metallic substrate. These coatings are used preferentially where the substrate is exposed to atmospheric corrosion and not where immersed in water or soil. The inhibitive mechanism relies on passivation of the metal and the build-up of a layer of metallic complexes as a result of the passivation reaction. The metallic complexes impede the transport of aggressive species such as Cl⁻ or H⁺ ions or dissolved oxygen to the metal of the substrate.

The active constituents/pigments of inhibitive coatings are typically marginally water soluble and produce cations on solution. Phosphates are commonly used but chromates, molybdates, nitrates, borates and silicates are also used. The selection of active components is increasingly subject to regulatory pressures due to increased concerns for the environment and health and safety.

Current regulations restrict the materials which can be used in inhibitory coatings. Chrome(VI) compounds have been subject to authorisation under REACH (2008 Annex XIV). Other legislative measures relating to anticorrosive pigments include the ELV (End of Life vehicle) directive which has seen the phase out of lead pigments from 2003 and Chrome(VI) in primers and pre-treatments from 2007. Other regulations include WEEE (Waste Electrical and Electronic Equipment Directive 2006) and RoHS (Restriction of Hazardous Substances Directive 2002) directives which restricted use of Cr(VI) in white goods. In the US OSHA (Occupational Safety and health Administration regulation 2006) reduced employee permissible exposure to Cr(VI) 52 μg/m³ to 5 μg/m³. Zinc phosphate is also coming under increasing concern given that it is very toxic to aquatic organisms and may cause long-term adverse effects in the aquatic environment. Accidental ingestion of the material may be damaging to the health of the individual. Soluble zinc salts produce irritation and corrosion of the alimentary tract with pain, and vomiting. It is thus beneficial to reduce or eliminate such materials from anti corrosive coatings.

The mechanism of inhibitive pigments is based on the partial dissolution of the pigment by water diffused into the coating. At the surface of the metallic substrate the dissolved ions react with the metal and form a reaction product that passivates the surface. It is critical that the inhibitive pigment is sufficiently highly soluble to release ions for reaction. Too high a solubility can, however, result in blistering at the metal substrate/coating interface. An ideal inhibitive coating should form a barrier against water and detrimental ions while simultaneously releasing a sufficient quantity of inhibitor ions. These two requirements are antagonistic in principle and the inhibitive coating requires a balance between the barrier properties of the coating (the lower the permeability the better the barrier properties) and in the ability of pigment to solvate and the ions created to transfer to the coating substrate interface (the higher the permeability the greater the solvation and transfer of ions). The pigments used in inhibitive coatings may be classified according to their effect on the anodic and cathodic reactions of electrochemical cells formed at the metallic substrate/coating interface.

Cathodic inhibitors (typically inorganic salts of magnesium and manganese) suppress corrosion at the cathode by reaction with hydroxyl ions to form insoluble deposits increasing the cathodic resistance against polarisation. Anode inhibitors similarly reduce the rate of corrosion by increasing the anodic polarisation at the anode.

Phosphates and in particular zinc phosphate have found widespread application for some metals, for example steel. Zinc phosphate relies on passivation of steel through precipitation of basic salts and polarisation of the cathodic areas. The mechanism of formation of insoluble iron phosphate occurs via

Fe [symbol] Fe²⁺+2e⁻ (1)

O²+2H₂O+4e [symbol] 4OH⁻ (2)

Zn₃(PO₄)₂+2H₂O+4OH⁻ [symbol] 3Zn(OH)₂+2HPO₄²⁻ (3)

Fe²⁺+HPO₄²⁻ [symbol] FePO₄+H⁺+e⁻ (4)

According to the present invention there is provided a composition comprising a carrier medium, a first corrosion inhibitor in which the first corrosion inhibitor comprises at least one of an ion exchanged pigment, a silica, a calcium exchanged silica, an oxyaminophosphate salt of magnesium, and/or a mixture of an organic amine, a phosphoric acid and/or an inorganic phosphate and a metal oxide and/or a metal hydroxide, and a second corrosion inhibitor having a barrier mechanism in which the second corrosion inhibitor comprises one or more 2D material platelets in which the 2D material platelets comprise: nanoplates of one or more 2D materials and or nanoplates of one or more layered 2D materials and or graphite flakes in which the graphite flakes have one nanoscale dimension and 35 or less layers of atoms.

2D materials (sometimes referred to as single layer materials) are crystalline materials consisting of a single layer of atoms. Layered 2D materials consist of layers of 2D materials weakly stacked or bound to form three dimensional structures. Nanoplates of 2D materials and layered 2D materials have thicknesses within the nanoscale or smaller and their other two dimensions are generally at scales larger than the nanoscale.

2D materials used in the composition of the present invention may be graphene (C), hexagonal boron nitride (hBN), molybdenum disulphide (MoS₂), tungsten diselenide (WSe₂), silicene (Si), germanene (Ge), Graphyne (C), borophene (B), phosphorene (P), or a 2D in-plane heterostructure of two or more of the aforesaid materials.

Layered 2D materials may be layers of graphene (C), hexagonal boron nitride (hBN), molybdenum disulphide (MoS₂), tungsten diselenide (WSe₂), silicene (Si), germanene (Ge), Graphyne (C), borophene (B), phosphorene (P), or a 2D vertical heterostructure of two or more of the aforesaid materials.

The preferred 2D material is graphene.

Preferred graphenes are graphene nanoplates, bilayer graphene nanoplates, trilayer graphene nanoplates, few-layer graphene nanoplates, and graphene nanoplates of 6 to 10 layers of carbon atoms. Graphene nanoplates typically have a thickness of between 0.3 nm and 3 nm, and lateral dimensions ranging from around 100 nm to 100 μm.

Graphite flakes with at least one nanoscale dimension are comprised of at least 10 layers of carbon atoms. Preferred graphite flakes are graphite flakes with nanoscale dimensions and 10 to 35 layers of carbon atoms, graphite flakes with nanoscale dimensions and 10 to 30 layers of carbon atoms, graphite flakes with nanoscale dimensions and 25 to 35 layers of carbon atoms, graphite flakes with nanoscale dimensions and 20 or less layers of carbon atoms, graphite flakes with nanoscale dimensions and 25 or less layers of carbon atoms, graphite flakes with nanoscale dimensions and 30 or less layers of carbon atoms, graphite flakes with nanoscale dimensions and 15 to 25 layers of carbon atoms. It is preferred that the graphite flakes have lateral dimensions ranging from around 100 nm to 100 μm.

In some embodiments of the present invention the 2D material platelets are graphene platelets. Graphene platelets comprise one of or a mixture of two or more of graphene nanoplates, bilayer graphene nanoplates, few-layer graphene nanoplates, and/or graphite flakes with nanoscale dimensions and 25 or less layers.

According to a second aspect of the present invention, there is provided an Anti-corrosion coating comprising a composition according to the first aspect of the present invention. Such coatings may further comprise other constituents known to be of use in the formulation and/or manufacture of anti-corrosion coatings.

In some embodiments of the present invention the second corrosion inhibitor is present in the range of 0.05 wt % to 1.0 wt %, 0.05 wt % to 0.8 wt %, 0.05 wt % to 0.6 wt %, or 0.1 wt % to 0.5 wt %. In some embodiments of the present invention the second corrosion inhibitor is present at a rate of 0.1 wt % or 0.5 wt %.

The first corrosion inhibitor comprises at least one of an ion exchanged pigment, a silica, a calcium exchanged silica, an oxyaminophosphate salt of magnesium, and/or a mixture of an organic amine, a phosphoric acid and/or an inorganic phosphate and a metal oxide and/or a metal hydroxide.

Ion exchanged pigments, silicas, calcium exchanged silicas, and oxyaminophosphate salts of magnesium are all generally regarded as being non-hazardous substances. Mixtures of an organic amine, a phosphoric acid and/or an inorganic phosphate and a metal oxide and/or a metal hydroxide are generally regarded as being non-hazardous substances dependent on the metal used. Such substances are thus beneficial in that they offer much less environmental concern than previously used corrosion inhibitors.

In some embodiments of the present invention the first corrosion inhibitor comprises one or more of zinc chromate, zinc molybdate, zinc tungstate, zinc vanadate, zinc phosphite, zinc polyphosphate, zinc borate, zinc metaborate, magnesium chromate, magnesium molybdate, magnesium tungstate, magnesium vanadate, magnesium phosphate, magnesium phosphite, magnesium polyphosphate, magnesium borate, magnesium metaborate, calcium chromate, calcium molybdate, calcium tungstate, calcium vanadate, calcium phosphate, calcium phosphite, calcium polyphosphate, calcium borate, calcium metaborate, strontium chromate, strontium molybdate, strontium tungstate, strontium vanadate, strontium phosphate, strontium phosphite, strontium polyphosphate, borate, strontium metaborate, barium chromate, barium molybdate, barium tungstate, barium vanadate, barium phosphate, barium phosphite, barium polyphosphate, barium borate, barium metaborate, aluminium chromate, aluminium molybdate, aluminium tungstate, aluminium vanadate, aluminium phosphite, aluminium borate, and/or aluminium metaborate.

In some embodiments of the present invention, the carrier medium is an epoxy resin. As a result, a coating comprised of a composition according to some embodiments of the present invention will be comprised of an epoxy resin in which are encased the first and second corrosion inhibitors.

In some embodiments of the present invention the carrier medium is comprised of one or more suitable crosslinkable resins, non-crosslinkable resins, thermosetting acrylics, aminoplasts, urethanes, carbamates, polyesters, alkyds epoxies, silicones, polyureas, silicates, polydimethyl siloxanes, vinyl esters, unsaturated polyesters and mixtures and combinations thereof.

Epoxy resins and other materials that are suitable for use as the carrier medium for the present invention will, after a relatively short period of exposure to water or humidity, become saturated with water, dissolved oxygen and possibly dissolved ions such as Cl⁻ from sodium chloride or H⁺ ions from water. The oxygen and dissolved ions can, if they reach the interface between the coating and the metallic substrate lead to the creation of electrochemical cells and wet corrosion of the metallic substrate may ensue. The mechanism of such corrosion is well known and does not need to be discussed herein.

The first way a coating comprising a composition according to the present invention provides protection to a metal surface or substrate to which it is applied is by providing a barrier which reduces access of water and corrosive ions such as Cl⁻ or H⁺ to the metallic substrate. The level of protection is dependent on the integrity of the coating, its hydrophobicity, affinity for water and thickness of coating.

It has been found that a graphene film can effectively decouple a metallic substrate on which the film is deposited from the environment. It has been shown that a single atomic and defect free film of graphene is impermeable to gas, water and dissolved gasses and ions in that water. It has however been estimated that in the presence of a defect density of 1 um² water transportation through graphene can occur at speeds of >1 m/s. Such mass transport rates can account for the observed corrosion effects.

Graphene has many forms and growth of a film by CVD (Chemical Vapor Deposition) is well understood and can give rise to graphene films of 1-3 atomic layers. Such films are used frequently in experimentation in connection with graphene. Such techniques have limited commercial applicability because they enable only relatively small areas of film to be created or substrate to be coated. In commercial applications it is more typical for graphene to be used in the form of graphene nanoplatelets. Graphene nanoplatelets may be produced by either exfoliation of graphite or via synthetic solvothermal processes. Such graphene nanoplatelets may vary substantially in number of atomic layers, surface area, functionality and sp² content. Such variations impact on the physical properties of the graphene such as the conductivity of the graphene. Likewise, graphite flakes with nanoscale dimensions and 35 or less layers of carbon atoms, graphite flakes with nanoscale dimensions and 25 to 30 layers of carbon atoms, graphite flakes with nanoscale dimensions and 20 to 35 layers of carbon atoms, or graphite flakes with nanoscale dimensions and 25 to 35 layers of carbon atoms may be produced by either exfoliation of graphite or via synthetic solvothermal processes.

The inclusion of 2D material platelets, as the second corrosion inhibitor in compositions according to the present invention will, depending on concentration of incorporation of the 2D material platelets, and applied dry film thickness, result in multiple layers of 2D material platelets, in coatings comprising a composition according to the present invention. Each platelet is potentially several atomic layers thick. The presence of multiple layers of 2D material platelets, in the coating provides a complex and tortuous (labyrinthine) path for the penetration of water, any dissolved oxygen it carries, and any aggressive ions such as Cl⁻ or H⁺. This labyrinthine path significantly reduces the diffusion rate of water and substances dissolved in the water across the coating. This is evidenced by the results of a test of water vapour transmission rate for a coating comprising two types of commercially available graphene/graphitic platelets (A-GNP35 which has 6-14 layers of carbon atoms and A-GNP10 which has 25 to 35 layers of carbon atoms, both available from Applied Graphene Materials Plc) and a control. The results are shown in Table 1.

Graphene/graphitic platelets typically have a thickness of between 0.3 nm and 12 nm and lateral dimensions ranging from around 100 nm to 100 μm. As a result, and because of the graphene/graphitic platelet's high lateral aspect and surface area, a coating comprised of a composition according to the present invention may be significantly thinner than comparable coatings comprising other barrier mechanism substances/pigments such as micaceous iron oxide and/or aluminium flake. The same is true for other 2D material platelets. Further, it has been found that use of graphene platelets results in a coating with good adhesion and mechanical properties. In some embodiments of the present invention, the 2D material platelets are graphene platelets which have a D50 particle size of less than 45 μm, less than 30 μm, or less than 15 μm as measured by a Mastersizer 3000.

The thinness of the coatings comprised of a composition according to the present invention may have the benefit of a reduced weight of the coating.

In coatings comprising a composition according to the present invention, the 2D material platelets only have a barrier effect in the protection of metallic substrate. Without being bound by theory, it is thought that for electrically conductive 2D material platelets the conductivity of 2D material platelets, once encapsulated in a carrier medium such as an epoxy resin is not sufficient to materially impact electron flow in the coating and/or metallic substrate. It is also possible that the surface of the 2D material platelets is modified by absorption of various coating additives (such as wetting agents, defoamers, flow aids and the like used in the formulation of a composition according to the present invention). This lack of electrical connection between the platelets has the result that once corrosion of the metal substrate is initiated, the 2D material platelets do not appear to have any impact on slowing or preventing that corrosion.

In some embodiments of the present invention the 2D material platelets have a conductivity of around or less than 2.0×10⁵ S/m at 20° C. In some embodiments, the 2D material platelets comprises graphitic platelets or reduced graphite or graphene oxide platelets which have 35 layers or less of carbon atoms. In some embodiments, the 2D material platelets comprises graphitic platelets or reduced graphite or graphene oxide platelets which have 25 to 35 layers of carbon atoms. In these embodiments, the 2D material platelets have a relatively low conductivity which has the benefit that the 2D material platelets continue to act with a barrier mechanism if the encapsulation of the 2D material platelets in the carrier medium is not complete, for example as a result of damage to the structure of the carrier medium.

In compositions according to the present invention, the inclusion of at least one first corrosion inhibitor which comprises at least one of an ion exchanged pigment, a silica, a calcium exchanged silica, an oxyaminophosphate salt of magnesium, and/or a mixture of an organic amine, a phosphoric acid and/or an inorganic phosphate and a metal oxide and/or a metal hydroxide helps prevent corrosion or contain initiated corrosion.

These compounds of the first corrosion inhibitor are inorganic oxides having a large surface area and are loaded with ionic corrosion inhibitors by ion exchange with surface hydroxyl groups. The oxides are chosen for their acidic or basic properties to provide either cation or anion exchange (silica is used as a cation support, alumina for an anion support). The corrosion protection behaviour of the first corrosion inhibitors is controlled by the rate of ion release caused by solution of the ion exchange pigment.

Calcium exchanged silica ion exchange pigments offer an environmentally friendly alternative to chromium and zinc-based systems. Calcium exchanged silicas function through controlled diffusion as water and aggressive ions permeate the coating. The ions released by the ion exchange pigment react with the metallic substrate in a known fashion in connection with passivation. There are both anodic and cathodic reactions. Depending on the pH in the coating, silica of the ion exchange pigment can dissolve as silicate ions. When the metallic substrate is an iron alloy such as low or medium or high unalloyed carbon steel or low or high alloy steel this soluble fraction of the pigment, the silicate ions, can react with ferric ions at the coating metal substrate interface. This results in the formation of a protective layer on the surface of the metal. Parallel to this reaction, calcium cations or other metallic cations on the silica surface are released and, by reaction with the soluble silica, form a calcium silicate film in alkaline regions on the metal surface. This together with the iron silicate helps to reinforce the protective layer by formation of a mixed oxide layer on the metal surface. At the same time, calcium or other metallic cations are released and the silica captures aggressive cations entering the calcium silicate film. These processes of film and compound formation result in suppression of the corrosion reaction via a two-fold passivation mechanism:

adsorption of aggressive ions and the formation of a protective layer on the metallic substrate.

In some embodiments of the present invention the first corrosion inhibitor comprises at least one oxyaminophosphate salt of magnesium. The oxyaminophosphate salts of magnesium constitute alternative environmentally friendly anticorrosive materials. Immediately after exposure of an oxyaminophosphate salt of magnesium to humidity, the amine of that salt passivates the metal surface by known passivation mechanisms. As a result of that passivation, a protective layer, composed mainly of magnesium oxide, is deposited on the surface of the metallic substrate, the layer being approximately 25-50 nm thick. When the metallic substrate is steel, the protective layer keeps the metal surface passive by providing anodic inhibition. When the metallic substrate is aluminium or an aluminium alloy, the magnesium oxide layer keeps the potential above the corrosion potential of the aluminium or aluminium alloy thus providing cathodic inhibition.

Electrochemical Impedance Spectroscopy (EIS) studies have shown that while graphene has in its natural state a high level of conductivity, when incorporated in an epoxy resin (epoxy resins are generally good electrical insulators) as platelets, this conductivity is significantly reduced. This is especially so when the epoxy resin contains other amorphous or crystalline additives such as pigments and fillers creating a homogeneous but highly disordered matrix. In such a matrix, the graphene platelets will not exhibit any significant electrical conductivity and consequently will not impart any cathodic protection or offer any benefit to the corrosion potential at the surface of the metallic substrate.

A benefit of the compositions according to the present invention is that the first and second corrosion inhibitors act synergistically with each other. In particular, the combination of the first and second corrosion inhibitors within the same carrier medium has the benefit of increasing the service life of a coating comprised of a composition according to the present invention. That enhancement can be significant and may be in excess of double, triple or quadruple the service life of known anti-corrosive coatings. In this context, service life is to be understood to be the period of time between application of the coating and the need to reapply the coating because of degradation of the coating first applied. In terms of International Standards Organisation standard 4628-3: 2005, the service life is the period of time between application of the coating and when a rust assessment of grade Ri3 occurs.

Without wishing to be bound by theory, it is understood that the increase in service life for the coating is achieved for the reasons set out below. The reasons refer to second corrosion inhibitor as being graphene, but the same reasons apply for all 2D material platelets. The reasons are:
The first and second corrosion inhibitors in the form of graphene platelets are substantially homogeneously mixed in the carrier medium with the result that some of the first corrosion inhibitor is proximal to the interface between the coating and the metallic substrate and does not have any graphene platelets between the first corrosion inhibitor and the metallic substrate. That portion of the first corrosion inhibitor will be termed the “metal proximal first corrosion inhibitor”;
The metal proximal first corrosion inhibitor can dissociate from humidity experienced during the application of the coating and the ions released as a result will passivate the surface of the metal substrate;
The graphene platelets distributed through the carrier medium create labyrinthine paths between the face of the coating remote from the metallic substrate and the face of the coating adjacent the metallic substrate;
The portion of the first corrosion inhibitor that is not the metal proximal first corrosion inhibitor is distributed throughout the matrix of graphene platelets that define the labyrinthine paths;
The labyrinthine paths created by the graphene platelets inhibit the diffusion of water, dissolved oxygen, and/or dissolved ions from the face of the coating remote from the metallic substrate to the face of the coating adjacent the metallic substrate;
While the water, dissolved oxygen, and dissolved ions diffuse along the labyrinthine paths from the face of the coating remote from the metallic substrate they encounter the first corrosion inhibitor in those paths, and cause that first corrosion inhibitor to dissolve and dissociate;
The ions from the first corrosion inhibitor then react with any ions in the water, or diffuse among the labyrinthine paths towards the metallic substrate;
The slow diffusion of water, dissolved oxygen, and/or dissolved ions along the labyrinthine paths has the effect that it takes a considerable time for the first corrosion inhibitor in the coating to be fully dissolved with the result that there is a considerable period before the first corrosion inhibitor in the coating is exhausted and the benefit of the first corrosion inhibitor is finished. That period is greater than for known anti-corrosive coatings and as such the coating has an increased service life.

The increased service life of coatings comprising compositions according to the present invention has a significant economic benefit because the application of corrosive coatings is expensive both in terms of labour and materials costs, and a significant ecological benefit because less coatings are being used and, as described above, the content of the coatings may be ecologically better than known coatings.

### EXAMPLE

A composition according to the present invention is manufactured with the constituents shown in Table 2.

Constituents 1 to 5 are charged into a high speed overhead mixer and mixed at 2000 rpm for 10 minutes. The resultant gel is checked to see if it is homogenous and free of bits. If not, mixing is continued until the gel is homogenous and free of bits.

Constituents 6 to 8 are added to the mixer and mixed at 2000 rpm for 15 minutes. The mixture is checked to see if the grind (maximum particle size) is less than 25 μm. This is known as the grind stage of the manufacture.

Constituent 9 is pre-dispersed into Constituent 10. The subsequent dispersion is then added alongside constituent 11 and are mixed at 1000 rpm for 15 minutes. This is known as the let down stage of the manufacture. If constituent 9 were added after this mixing step, such an addition would be at the post addition stage of manufacture.

A polyamide curing agent 12 was added at 10 wt % (85% stoichiometry) and the composition was then ready for application to a substrate to form an anti-corrosive coating.

To perform comparative testing on compositions according to the present invention, such compositions were manufactured as above. Further compositions were manufactured using the same method but not including constituent 7 and/or 9 and including constituent 10.

For constituent 7, different compositions were made using one of four commercially available anti-corrosion pigments. They were zinc phosphate (Delaphos 2M commercially available from Delaphos—Part of JPE Holdings Ltd), Pigmentan E with a loading range of 0.5-2.4 wt % available from Banner Chemicals, part of 2M Holdings Limited, Inhibisil® 75 with a loading range of 1.0-10.0 wt % available from PPG Industries, Inc., and Shieldex AC5 with a loading range of 1.2-2.4 wt % available from W.R. Grace & Co. Pigmentan E has an active ingredient of an oxyaminophosphate salt of magnesium. Inhibisil 75 and Shieldex AC5 have as an active ingredient ion exchange pigments in the form of silica or calcium exchanged silica.

The graphene/graphitic platelets used were commercially available from Applied Graphene Plc as A-GNP10 or A-GNP35 grades (A-GNP35 which has 6 to 14 layers of carbon atoms and A-GNP10 which has 25 to 35 layers of carbon atoms, both available from Applied Graphene Materials Plc).

Samples for testing were prepared in the following fashion:

Substrates of cold rolled steel were prepared by grit blasting to SA2-1/2, using irregularly shaped chrome/nickel steel shot followed by degreasing with acetone. Each of composition numbers 1 to 18 were applied by spray application to a substrate using a gravity-fed gun with a 1.2 mm tip to give a coating thickness of DFT 60-75 μm. The substrates were cured for 7 days.

A substrate coated with each composition was subject to cyclic salt spray testing (ASTM G85 annex 5) and assessed at intervals of 1, 2, 3 and 4 thousand hours. The results of the assessments are as shown in Tables 3, 4, 5, and 6.

A substrate coated with each composition was subject to assessment in connection with the mechanical performance of the coatings. Specifically, the coatings were assessed in connection with impact resistance (using the Elcometer Impact test), abrasion resistance (using a Taber abrader and 100 Cycles, 1 Kg Weight, CS-10 Discs), adhesion (using a PAT device), and flexibility (using a Conical mandrel). The results of that assessment are shown in Tables 7, 8, 9, and 10 the following test methods being used

Abrasion resistance: Taber abrasion—ASTM 5144

Flexibility: Conical Mandrel—ISO6860:2006

Impact resistance:—ISO6272

Adhesion—ISO4624

The assessment reveals that compositions according to the present invention provide better corrosion resistance than known coating compositions, are better for the environment than known compositions, and have longer service lives than known coating compositions.

In the formulation of the compositions 1 to 18, the graphene platelets can be incorporated into the composition at the grind stage, the let down stage, or after all the other constituents have been combined. It has been found that the time of incorporation of the graphene platelets has an effect on the anti-corrosive properties of coatings resultant from the composition. The best properties were achieved when the incorporation of the graphene platelets occurred at the let down stage of manufacture.

To test the theory that the graphene/graphitic platelets in the composition of the present invention have a barrier effect only, and without wishing to be bound by theory, AC Electrochemical Impedance Spectroscopy (AC EIS) and Corrosion Potential (E_{corr}) measurements have been taken in connection with some of the samples for testing that were prepared as discussed above. AC EIS and E_{corr}, measurements allow the quantitative determination of several properties related to corrosion resistance of a sample without the prolonged testing required of artificial weathering.

E_{corr}—Electrochemical corrosion potential (ECP) is the voltage difference between a metal immersed in a given environment and an appropriate standard reference electrode (SRE), or an electrode which has a stable and well-known electrode potential. Electrochemical corrosion potential is also known as rest potential, open circuit potential or freely corroding potential, and in equations it is represented by E_{corr}. Higher values of E_{corr} indicate lower corrosion rates, and lower values higher corrosion rates.

The barrier properties of organic coatings, for a coating where the carrier medium is an epoxy resin or other suitable organic composition, are such that they exhibit a high impedance across the coating thickness. Traditionally it is understood that as a coating ages the interconnecting network of pores within the coating become saturated with water and salts exposing the metal substrate to a corrosive environment while also lowering the electrical resistance of the coating. Aged organic coatings also possess other electric properties which cause the coating to behave as capacitors to electric current. When corrosion occurs at the metal surface a polarisation resistance can be related to the corrosion rate while the electrical double layer behaves as a capacitor. The measurements made below were used to explain the performance of coatings of various of the samples prepared as described above.

In order to demonstrate the mechanism of the graphene/graphitic platelets in a coating of a composition of the present invention, and the relationship with active inhibitors in providing corrosion prevention, the samples were evaluated with and without a scribe through the coating. The scribe provides direct access of the salt solution to the metal surface and demonstrates through the electrochemical reaction the nature of any resistance to corrosion on damage to the coating. In evaluating coatings in this manner it is possible to demonstrate the mechanisms of action operating in intact films.

All electrochemical measurements were recorded using a Gamry 1000E potentionstat in conjunction with a Gamry ECM8 multiplexer to permit the concurrent testing of up to 8 samples per experiment. Each individual channel was connected to a Gamry PCT-1 paint test cell with an exposed paint surface of 14.6 cm², specially designed for the electrochemical testing of coated samples. One panel for each Formulation and Control was scribed with a 25 mm scribe using a knife. Care was taken that the scribes were as consistent as possible throughout due to relatively small surface area of study. The panels for each Formulation and Control were tested in duplicate in both scribed and unscribed forms.

Within each paint test cell, a conventional three-electrode system was formed, the bare steel, epoxy coated steel, and scribed epoxy coated steel panels were the working electrode, a graphite rod served as a counter electrode and a saturated calomel electrode (SCE) served as the reference electrode. All tests were run using a 3.5 wt % NaCl electrolyte. All corrosion potential (E_{corr}) measurements were recorded against the SCE reference electrode. EIS analysis was carried out using reference to a modified Randle cell incorporating pore resistance.

The AC EIS data shown in Tables 11 to 23 was obtained by fitting of equivalent circuits to EIS data.

Pore resistance or Rₚₒᵣₑ is the electrical resistance to current travelling through the pore network in the coating. As the pore network fills with electrolyte Rₚₒᵣₑ changes. Higher values indicate lower rates of corrosion, and lower values a higher rate of corrosion.

C_{DL} is the capacitance produced by the electric double layer at the water/substrate interface. A measurable C_{DL} indicates that water is present at the substrate. Higher values indicate a greater wetted area of substrate.

C_{c} is the capacitance produced by the dielectric properties of the coating. The C_{c} is related to the dielectric strength of the coating and water absorption by the coating with higher values indicating higher water content

Tabular representations of the data measured are as shown in Tables 11 to 23. Each Table shows in the title the composition used to coat the sample being tested.

Commentary on Tables 11 to 23:

Corrosion Potential:

Tables 11 to 15 demonstrate the behaviour of E_{corr} with time over the period of test. It can be seen in the Composition 1 that without scribing there is a steady reduction of the corrosion potential with time indicating slow moisture diffusion and onset of corrosion. With the scribe there is no difference in the E_{corr} determined from that of uncoated steel which was to be expected.

Table 12 demonstrates the impact of inclusion of graphitic platelets (A-GNP10) in Composition 2 on unscribed panels. The graphene containing panel holds a higher corrosion potential and therefore resistance to corrosion compared to Composition 1. Table 13 however shows that when scribed there is no difference between the graphitic platelets containing Composition 2 and the Composition 1 or indeed uncoated steel suggesting that the behaviour of graphitic platelets is solely based on barrier performance and has no additional electrochemical activity on steel surfaces.

Tables 14 and 15 show the behaviour of Compositions 4 and 12. The unscribed Composition 12 indicates a higher E_{corr} than Composition 4 suggesting higher corrosion protection. The results for scribed Composition 12 indicates that the activity of both Compositions 4 and 12 is close to that of uncoated steel with Composition 12 being slightly worse. This is not reflected in the results of the artificial weathering (salt spray tests) and is possibly a reflection of the short time period of the test and activity of the active component in that time frame.

Pore Resistance Rₚₒᵣₑ and Coating Capacitance C_{c}:

Tables 16 to 19 demonstrate the behaviour of the Pore resistance and Coating Capacitance. Comparison of the unscribed Compositions 1 and 2 are as expected. The graphitic platelets in Composition 2 enhance the pore resistance with a resulting lower coating capacitance indicating that there is less water at the coating/metal interface. Scribing of the sample panels results in there being no difference in performance.

Comparison of unscribed Compositions 4 and 12 demonstrates the greater performance of Composition 12. The scribed panels however do not reveal significant differences.

Double Layer Capacitance C_{DL}:

Tables 20 to 23 show the double layer capacitance of the coatings and the water at the surface of the coating/metal interface. In both scribed and unscribed panels the compositions including graphene/graphitic platelets show enhanced barrier performance of the coating with less moisture being present at the coating/metal interface. This confirms the barrier properties of graphene. This is also reflected in the tests on Compositions 4 and 12 where the double layer capacitance of Composition 12 appears to be lower. This is reflected in the accelerated corrosion testing (salt spray) tests.

Within the scope of this application it is expressly intended that the various aspects, embodiments, examples and alternatives set out in the preceding paragraphs, and/or in the claims, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

1. A composition comprising a carrier medium, a first corrosion inhibitor having a passivation mechanism, and a second corrosion inhibitor having a barrier mechanism in which the first corrosion inhibitor comprises at least one of an ion exchanged pigment, a silica, a calcium exchanged silica, an oxyaminophosphate salt of magnesium, and/or a mixture of an organic amine, a phosphoric acid and/or an inorganic phosphate and a metal oxide and/or a metal hydroxide, and the second corrosion inhibitor comprises one or more 2D material platelets in which the 2D material platelets comprise; nanoplates of one or more 2D materials and or nanoplates of one or more layered 2D materials and or graphite flakes in which the graphite flakes have one nanoscale dimension and 35 or less layers of atoms, wherein the second corrosion inhibitor has a D50 particle size of less than 45 μm, less than 30 μm, or less than 15 μm.

2. A composition according to claim 1 in which the 2D materials are one or more of graphene (C), hexagonal boron nitride (hBN), molybdenum disulphide (MoS2), tungsten diselenide (WSe2), silicene (Si), germanene (Ge), Graphyne (C), borophene (B), phosphorene (P), or a 2D in-plane heterostructure of two or more of the aforesaid materials.

3. A composition according to claim 1 in which the layered 2D materials may be layers of graphene (C), hexagonal boron nitride (hBN), molybdenum disulphide (MoS2), tungsten diselenide (WSe2), silicene (Si), germanene (Ge), Graphyne (C), borophene (B), phosphorene (P), or a 2D vertical heterostructure of two or more of the aforesaid materials.

4. A composition according to claim 1 in which the 2D material platelets have an electrical conductivity of around or less than 2.0×10⁻⁵/m at 20° C.

5. A composition according to claim 1 in which the first corrosion inhibitor comprises one or more of zinc chromate, zinc molybdate, zinc tungstate, zinc vanadate, zinc phosphite, zinc polyphosphate, zinc borate, zinc metaborate, magnesium chromate, magnesium molybdate, magnesium tungstate, magnesium vanadate, magnesium phosphate, magnesium phosphite, magnesium polyphosphate, magnesium borate, magnesium metaborate, calcium chromate, calcium molybdate, calcium tungstate, calcium vanadate, calcium phosphate, calcium phosphite, calcium polyphosphate, calcium borate, calcium metaborate, strontium chromate, strontium molybdate, strontium tungstate, strontium vanadate, strontium phosphate, strontium phosphite, strontium polyphosphate, borate, strontium metaborate, barium chromate, barium molybdate, barium tungstate, barium vanadate, barium phosphate, barium phosphite, barium polyphosphate, barium borate, barium metaborate, aluminium chromate, aluminium molybdate, aluminium tungstate, aluminium vanadate, aluminium phosphite, aluminium borate, and/or aluminium metaborate.

6. A composition according to claim 1 in which the second corrosion inhibitor is present in the range of 0.05 wt % to 1.0 wt %, 0.05 wt % to 0.8 wt %, 0.05 wt % to 0.6 wt %, or 0.1 wt % to 0.5 wt %, 0.1 wt % or 0.5 wt %.

7. (canceled)

8. A composition according to claim 1 in which the first corrosion inhibitor is present in the range of 1 wt % to 15 wt %, 2 wt % to 10 wt %, 4 wt % to 8 wt %, 4 wt % or 8 wt %.

9. A composition according to claim 1 in which the first corrosion inhibitor is comprised of a calcium exchanged silica, and the second corrosion inhibitor is or is comprised of graphite flakes having one nanoscale dimension and 25 to 35 layers of carbon atoms.

10. A composition according to claim 1 in which the carrier medium is selected from crosslinkable resins, non-crosslinkable resins, thermosetting acrylics, aminoplasts, urethanes, carbamates, polyesters, alkyds epoxies, silicones, polyureas, silicates, polydimethyl siloxanes, vinyl esters, unsaturated polyesters and mixtures and combinations thereof.

11. A coating comprising a composition according to claim 1.

12. A method of manufacture of a composition according to claim 1 in which the manufacture comprises a grind stage and a let down stage, and the 2D material platelets are added at the grind stage, at the let down stage, or as a stir in additive after the let down stage.

13. A method of manufacture of a composition according to claim 12 in which the 2D material platelets are added at the let down stage

14. A method of manufacture of a composition according to claim 12 in which the grind stage comprises mixing the carrier medium and the first corrosion inhibitor.

15. A coating according to claim 11, wherein the coating has a dry film thickness of from 60 μm to 75 μm.

16. A coating according to claim 11, wherein the coating comprises multiple layers of 2D material platelets providing a labyrinthine path for the penetration of water, any dissolved oxygen it carries, and any aggressive ions such as Cl⁻ or H⁺.
